(19) United States
(12) Patent Application Publication
(10) Pub. No.: US 2008/0048366 A1
(43) Pub. Date: Feb. 28, 2008

(54) Method and Apparatus For Imparting Compound Folds on Sheet Material

(75) Inventor: Max W. Durney, San Francisco, CA (US)

Correspondence Address: MORGAN, LEWIS & BOCKIUS, LLP, ONE MARKET SPEAR STREET TOWER, SAN FRANCISCO, CA, 94105, US

(73) Assignee: Industrial Origami, Inc., San Francisco, CA (US)

(21) Appl. No.: 11/846,134

(22) Filed: Aug. 28, 2007

Related U.S. Application Data
(60) Provisional application No. 60/840,810, filed on Aug. 28, 2006.

(51) Int. Cl. B28B 11/00

(52) U.S. Cl. 264/339; 425/403

(57) ABSTRACT

A method and apparatus for imparting compound folds on sheet materials includes a tool base for receiving and supporting the sheet material, a locator for positioning the sheet material relative to the work base, and a bend actuator mounted on the tool base. The bend actuator has an actuator member movable between an initial retracted position and a deployed extended position for applying a force against an unsecured portion of sheet material to effect bending of the sheet material about the first fold line as the actuator member moves from the initial retracted position and contacts the unsecured portion. The bend actuator also has a contact member positioned to abut against an outer portion of the unsecured portion as the actuator member continues to bend the sheet material about the first fold line, wherein the contact member effects bending of the sheet material along the second fold lines as the actuator member continues moving toward the deployed extended position. A method of using the method and apparatus for imparting compound folds on sheet materials is also disclosed.

### BACKGROUND OF THE INVENTION

1. Field of the Invention

This invention relates, in general, to tool systems for bending sheet materials and methods for their use.

2. Description of Related Art

Bending two-dimensional (2D) sheet materials to form three-dimensional (3D) structures is known. Machinery and tooling for effecting bends in 2D sheet materials is also known. Generally, such machinery and tooling receives the sheet material in a horizontal orientation. For example, U.S. Pat. No. 4,133,198 to Huda et al. discloses an apparatus for bending large area construction units. U.S. Pat. No. 4,230,058 to Iwaki et al. shows an apparatus that is configured to manufacture box-shaped structures from metal sheet. U.S. Pat. No. 5,105,640 to Moore discloses an apparatus for forming box-shaped sheet metal ducts from sheet material.

Such known apparatuses generally have presses and/or clamping members which serve to clamp and/or bend the sheet material. While such componentry may be effective in their intended purposes, such apparatuses generally require a process or operational step dedicated to forming each bend in the sheet material. Furthermore, such apparatuses are generally “hard” tooled, that is, specifically designed to work with a specific bending operation. As such, another disadvantage of such known apparatuses is that they are generally configured for forming a particular 3D structure and may require significant time and expense in retooling in order to be used with another 3D structure.

What is needed is a tool system for bending sheet materials which overcomes the above and other disadvantages of known bending machinery and tooling.

### BRIEF SUMMARY OF THE INVENTION

In summary, one aspect of the present invention is directed to a bending tool system for forming a three-dimensional structure from a two-dimensional sheet material which includes first and second predetermined fold lines. The system includes a tool base for receiving and supporting the sheet material, a locator for positioning the sheet material relative to the work base, and a bend actuator mounted on the tool base. The bend actuator includes an actuator member movable between an initial retracted position and a deployed extended position for applying a force against an unsecured portion of sheet material to effect bending of the sheet material about the first fold line as the actuator member moves from the initial retracted position and contacts the unsecured portion. The bend actuator also includes a contact member positioned to abut against an outer portion of the unsecured portion as the actuator member continues to bend the sheet material about the first fold line, wherein the contact member effects bending of the sheet material along the second fold lines as the actuator member continues moving toward the deployed extended position.

In one embodiment, the tool base includes clamping means for securing the sheet material to the tool base. The bend actuator may further include a driver operably connected to the application member, wherein actuation of the driver moves the application member between the initial retracted position and the deployed extended position.

The driver may be a pneumatic cylinder having a cylinder stroke. A first portion of the cylinder stroke may effect movement of the actuator member to contact the unsecured portion and effect bending about the first fold line, and a second portion of the cylinder stroke may effect movement of the actuator member effect bending along the second fold line. The second portion of the cylinder stroke may also continue to effect bending about the first fold line.

The sheet material may have a plurality of sets of predetermined fold lines, and the system may include a plurality of bend actuators. The bend actuator may be positioned to effect bending along a respective set of fold lines.

In one embodiment, the system includes a mounting bracket connecting the bend actuator to the tool base. The mounting bracket may adjustably secure the bend actuator to the tool base. the system may include a contact member bracket adjustably mounting the contact member on the mounting bracket. The system may include a height adjuster for adjusting the height of the contact member with respect to the mounting bracket and the tool base. The system may include a angle adjuster for adjusting the angle of the contact member with respect to the mounting bracket and the tool base.

The actuator member may be pivotally mounted a pivot axis, wherein the pivot axis may be fixed with respect to the tool base. The bend actuator may include a supplemental cylinder to pivot the contact member from an outer position adjacent the second fold line to an inner position adjacent the first fold line.

Another aspect of the present invention is directed to a method for forming a three-dimensional structure from a two-dimensional sheet material which includes first and second predetermined fold lines. The method includes the steps of: positioning a sheet material on a tool base for receiving and supporting the sheet material in a work plane; initially moving an actuator member from an initial retracted position and applying a force against an unsecured portion of sheet material to effect bending of the sheet material about the first fold line as the actuator member contacts the unsecured portion and continues to move to an intermediate position at which the unsecured portion contacts a contact member; and continually moving the actuator member from the first intermediate portion and beyond the intermediate position to continue bending the sheet material about the first fold line such that the unsecured member slides along the contact member to effect bending of the sheet material along the second fold lines as the actuator member continues moving toward the deployed extended position.

The method may include the step of clamping the sheet material to the tool base. The initially moving and the continually moving steps may be effectuated by pneumatically moving the application member. The method may include the step of adjustably securing the bend actuator to the tool base. The method may include the step of adjustably mounting the contact member with respect to the tool base.

The method and apparatus for imparting compound folds on sheet materials of the present invention has other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 is an isometric view of a bending apparatus having actuators for imparting compound folds on a sheet material in accordance with the present invention.

FIG. 2A is a plan view of the sheet material of FIG. 1, and FIG. 2B, FIG. 2C and FIG. 2D are isometric views of the sheet material shown in sequential stages of folding.

FIG. 3A is a schematic side view of one of the actuators of FIG. 1, with FIG. 3B being an enlarged detail thereof.

FIG. 4A and FIG. 4B are schematic side views of another actuator similar to those shown in FIG. 1, the actuator shown in initial and deployed positions, respectively.

FIG. 5A, FIG. 5B, FIG. 5C and FIG. 5D are schematic side views of another actuator similar to those shown in FIG. 1, the actuator shown in sequential positions of a single operation.

FIG. 6A and FIG. 6B are perspective views of a sheet material configured for folding on a bending apparatus in accordance with the present invention, with figure FIG. 6B being an enlarged detail of FIG. 6A.

FIG. 7A and FIG. 7B are perspective views of the sheet material of FIG. 6A and FIG. 6B after folding on a bending apparatus in accordance with the present invention, with figure FIG. 7B being an enlarged detail of FIG. 7A.

FIG. 8A, FIG. 8B, FIG. 8C, FIG. 8D, FIG. 8E, FIG. 8F, FIG. 8G, FIG. 8H, FIG. 8I, FIG. 8J, FIG. 8K and FIG. 8L are schematic side views of another actuator similar to those shown in FIG. 1, the actuator shown in sequential positions.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

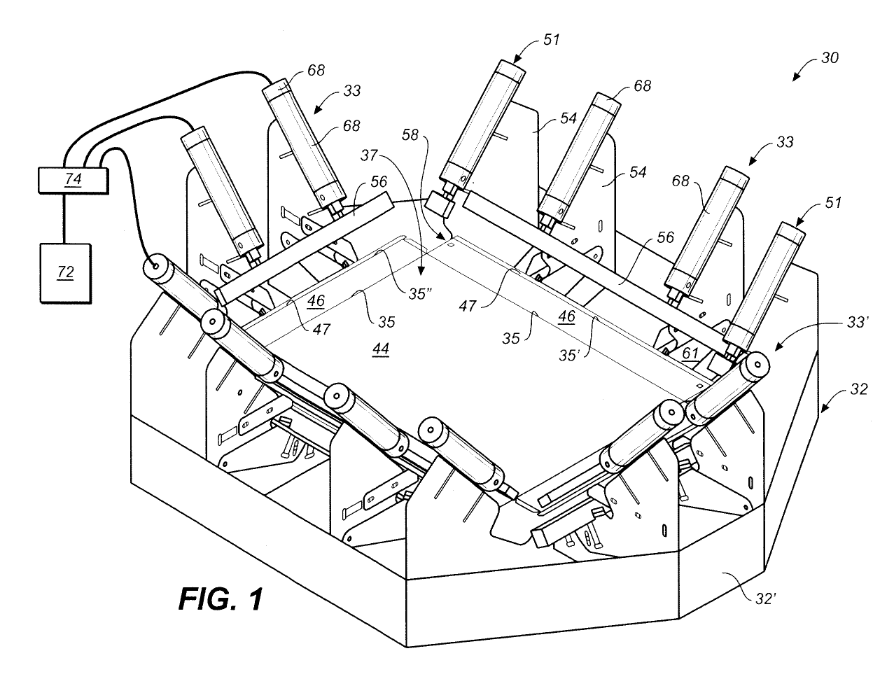

Turning now to the drawings, wherein like components are designated by like reference numerals throughout the various figures, attention is directed to FIG. 1 which illustrates a bending tool system generally designated by the numeral 30 that may be used to fold two-dimensional (2D) sheet materials into three-dimensional (3D) shapes.

The bending tool system of the present invention is particularly suited for bending 2D sheet materials having engineered fold lines utilizing various fold geometries and configurations including, but not limited to, those disclosed by U.S. Pat. No. 6,481,259 to Durney, U.S. patent application Ser. No. 10/256,870 filed Sep. 26, 2002 (now U.S. Patent Application Publication No. US 2005/0061049 A1), U.S. patent application Ser. No. 10/672,766 filed Sep. 26, 2003 (now U.S. Patent Application Publication No. US 2004/0134250 A1), U.S. patent application Ser. No. 10/795,077 filed Mar. 3, 2004 (U.S. Patent Application Publication No. US 2004/0206152 A1), U.S. patent application Ser. No. 10/821,818 filed Apr. 4, 2004 (now U.S. Patent Application Publication No. US 2005/0005670 A1), and U.S. patent application Ser. No. 10/861,726 filed Jun. 4, 2004 (now U.S. Patent Application Publication No. US 2005/0126110 A1), the entire contents of which patent and patent applications are incorporated herein by this reference. The bending tool system of the present invention allows the use of 2D sheet materials to build 3D structures around components in a manner that is described in the above mentioned patents.

One will appreciate, however, that the bending tool system of the present invention is also suited for bending other types of sheet materials about a fold line including, but not limited to, the above-mentioned engineered fold lines, predetermined fold lines defined by scoring and/or other suitable means, or intended bend lines in which the sheet materials do not have any physical structure extending along the bend line for promoting bending along the bend line.

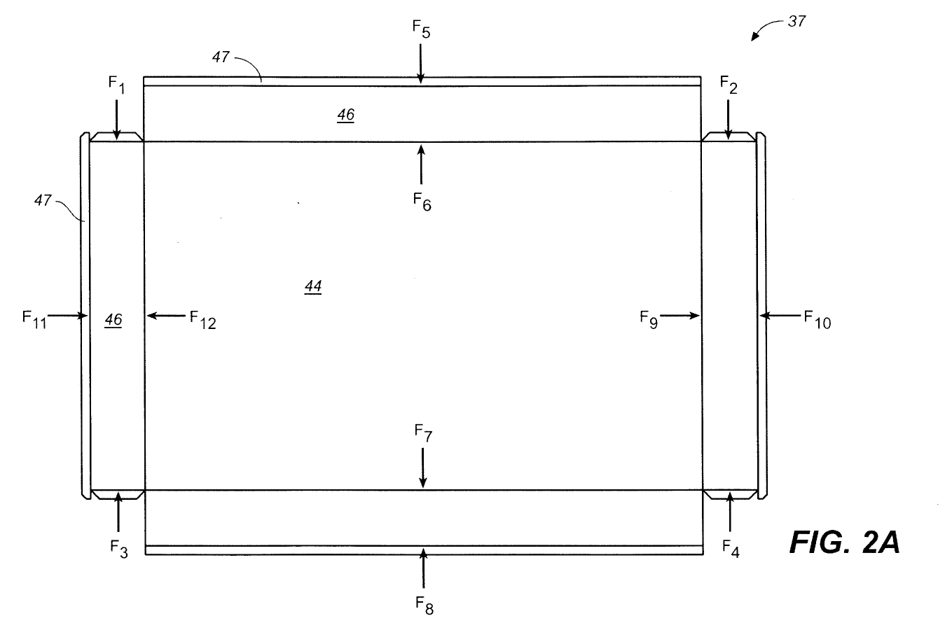

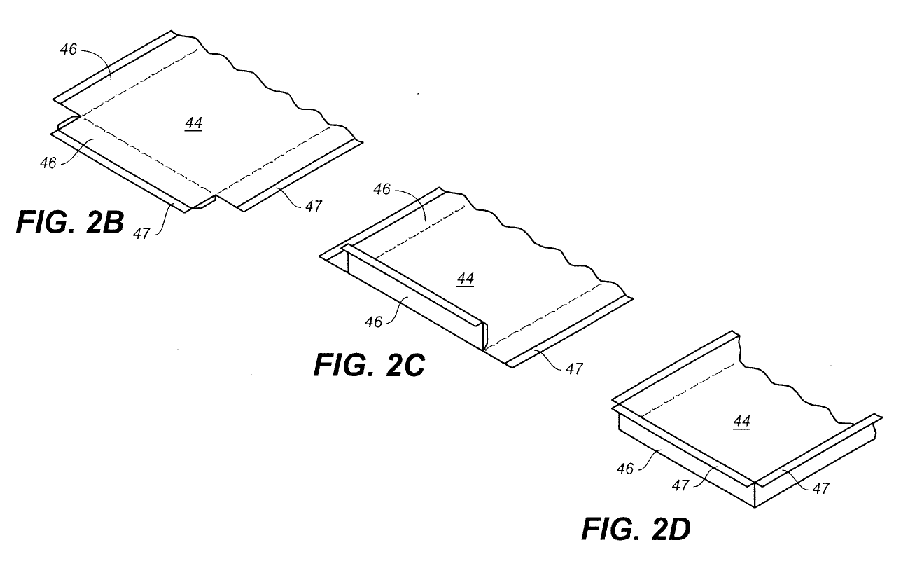

Generally, bending tool system 30 includes a tool base 32 and one or more bend actuators 33 which are arranged such that each is positioned along a corresponding set of fold lines 35, 35′ of a sheet material work piece 37. The bend actuators are configured to apply force against an unsecured portion of the work piece intermediate the corresponding set of fold lines to effect bending along the fold lines during a single stage operation, as is discussed in greater detail below. In the illustrated embodiment, the bending tool system is configured for bending a flat work piece 37 (see, e.g. FIG. 2A) into a flanged box (see, e.g. FIG. 2D). For example, the work piece may be used for a burner box of a gas cooktop or range stovetop.

Tool base 32 may be formed of a metal framework or other suitable structure which provides a stable base for supporting bend actuators 33. The tool base may be dedicated to a particular work piece (i.e., “hard” tooled) such that the tool base positions one or more actuators specifically located along each fold line of a particularly shaped work piece. Alternatively, and as shown in FIG. 1, the tool base may adjustably receive the actuators to allow the apparatus to be used for work pieces of various sizes. In this regard, bend actuator 33′ may be slid or positioned inwardly from base end wall 32′ in an otherwise conventional manner to accommodate a shorter work piece. One would appreciate that other bend actuators may similarly be adjusted along with, or instead of bend actuator 33′.

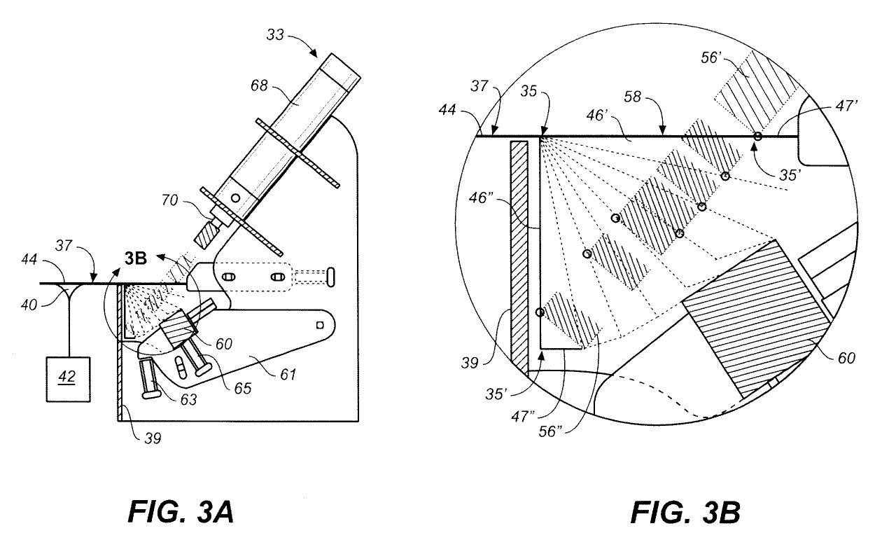

Preferably, the tool base includes a support wall 39 (see FIG. 3A) which extends along and slightly within a corresponding set of fold lines, and more particularly, within the profile of the inner fold line 35. Preferably, the tool base also includes one or more locators 40 to laterally position the work piece on tool base. For example, the locator may be in the form of a suction or vacuum clamp 40 which engages against the undersurface of the work piece and holds the work piece firmly against the top of the support wall 39, and thus firmly positioning the work piece with respect to the bend actuators. The vacuum clamp is operably connected to a vacuum source 42 or other suitable control means in a well-known manner. One will appreciate that other locating means may be used to secure the position of the work piece relative to the actuators including, but not limited to, C-claims, hook clamps, pneumatic clamps, and other suitable means. In this regard, one will appreciate that such clamps may be configured to act engage the work piece and either pull it or push it against the support walls or other suitable structure of the tool.

In accordance with the present invention, the work piece will have one or more sets of predefined fold lines. In the illustrated embodiment, the work piece is configured to form a flanged box. For example, work piece 37 illustrated in FIG. 2A has four individual fold lines and four sets of fold lines, which when folded form a box having a bottom 44, four sides 46, four corresponding flanges 47, and four tabs 49 for securing the box once it has been folded, as shown in FIG. 2D. The work piece may have one or more a preferred fold sequences. For example, the finished 3D box may be formed from the flat sheet material work piece by sequentially or simultaneously folding tabs 49 in fold steps F1, F2, F3 and F4, and then folding corresponding sides 46 and flanges 47 in a single step, namely effecting each of fold steps F5/F6, F7/F8, F9/F10, and F11/F12 in single stage operations. One will appreciate that fold steps F5/F6 and F7/F8 may be accomplished sequentially or simultaneously, as can be fold steps F9/F10 and F11/F12.

To effect folding of the tabs, one or more supplemental actuators 51 (FIG. 1) are provided to bend the respective tabs at a right angle. As such, the tabs may be fastened to a respective adjacent side in an otherwise conventional manner. For example, the tabs may be simple secured to a respective side with a fastener such as a nut and bolt, rivet, or other suitable means. Alternatively, the tabs may be secured using a self latching configuration of the type described in U.S. patent application Ser. No. 11/386,463 filed Mar. 21, 2006, the entire contents of which is incorporated herein by this reference.

As shown in FIG. 3A, bend actuator 33 includes a pair of single-stage drivers 53 which are secured to the tool base by respective mounting brackets 54. The drives control movement of an application member 56 from an initial retracted position (56′ in FIG. 3B) to a extended deployed position (56″ in FIG. 3B). As it moves, the application member contacts and applies force against an unsecured portion 58 of work piece 37 (e.g., against side 46) to effect bending along the inner fold line 35, by virtue of the remainder (e.g., bottom 44) of the work piece being clamped down.

The actuator also includes a contact member 60 which extends substantially parallel to the application member. The contact member, however, remains stationary during the bending process and simply serves as a contact surface against which the work piece will abut against as it is bent about inner fold line 35. Once a portion of the work piece (e.g., tab 49) contacts and abuts against the contact member 60, the contact resists motion of the unsecured portion 58 and causes the work piece to fold about the outer fold line 35′, as schematically shown in FIG. 3B. As a result, the work piece is folded along fold lines 35 and 35′ during a single operation.

By adjusting the positions of the application and contact members relative to the fold lines of the work piece, particular angular geometries can be imparted onto the work piece. For example, the position of contact member 60 shown in FIG. 3B is configured to impart a 90° angle between side 46 and tab 49. One may increase the angle to form an obtuse angle between the side and tab by moving the contact member downward, and decrease the angle to form an acute angle by moving the contact member upward. For such purposes, contact member bracket 61 is provided with an angle adjuster 63 and a height adjuster 65. The contact member bracket is preferably pivotally mounted on its respective mounting bracket 54. The angle and height adjusters may be in the form of threaded adjusters or other suitable means.

Also, the dimensions and configuration of the bend actuator will dictate the particular angle bend imparted on the work piece. For example, in the illustrated embodiment, bend actuator 33 is configured move application member sufficiently downward to impart a 90° bend on work piece 37 about fold line 35. One will appreciate, however, that the actuator may be adjustable such that the bend angle may be adjusted by adjusting the stroke of the driver, or by other suitable means. For example, the stroke of bend actuator 33 may be reduced to reduce the amount that side 46 is bent relative to bottom 44, thereby increasing the angle between the side and the bottom to form an obtuse angle therebetween. Similarly, the stroke of the bend actuator may be increased to increase the amount of bending, thereby decreasing the angle to form an acute angle.

With further reference to FIG. 3A, the bend actuators may also be provided with positioning brackets 67 which serve to locate work piece 37 relative to tool base # prior to folding. The positioning brackets may be used in conjunction with the locators described above, or instead of the locaters. For example, if diametrically opposed actuators on are actuated simultaneously, for example, to simultaneously accomplish fold steps F5/F6 and F7/F8, there will be no tendency for the work piece to pivot upwardly from the tool base, in which case, there will be no need to secure the work piece to the work base to prevent such upward pivoting. One will appreciate, however, that positively clamping the work piece to the tool base may promote accuracy in that the unsecured portions 58 of the work piece will be precisely registered with respect to application member 56 and contact member 60 during bending.

In the illustrated embodiment, each driver 53 includes a double-acting pneumatic cylinder 68. One will appreciate that other suitable actuator means can be used including, but not limited to, single-acting pneumatic cylinders, single or double acting hydraulic cylinders, electric motors, linear actuators and other suitable means to effect movement of the clamping hook and/or the application member. As cylinder 68 is actuated, a piston rod 70 extends downwardly and pushes application member 56 downward in the manner described above. The double-acting configuration of the cylinder allows positive retraction of the piston rod to move the application member back to its initial retracted position. Alternatively, if a single-acting cylinder is utilized, springs or other biasing members may be utilized in an otherwise conventional manner to return the application member to its initial position.

The actuators may be controlled by suitable means to control the pressure and dwell time of each actuator, as well as the actuation sequence of the actuators. For example, a programmable logic controller 72 having a 16 channel valve assembly 74 is provided to control actuators 33 in any desired combination duration and/or sequence. The controller may be configured with a manual override to activate any one or more actuators as desired, and/or a safety/off switch.

One will appreciate that the actual configuration of the controller may vary in accordance with the present invention. For example, the valve assembly may be configured to adjust the pressure applied to each actuator in order to adjust the amount of force each actuator applies to the work piece. Also, in the event that actuator means other than pneumatic cylinders are used, the controller may be configured to activate single or double acting hydraulic cylinders, electric motors or solenoids, and or other suitable actuator means.

Advantageously, the bending tool system of the present invention provides a simple and safe method of defining 3D objects from 2D sheet materials. The tool system may be used in the assembly environment instead of the fabrication environment as it obviates the use of press brakes, progressive dies and other heavy machinery. The bending tool system of the present invention may readily be located in an assembly line after or between various fabrication stations on which a profiling, punching, laser cutting or other operation takes place. Furthermore, the bending tool system may be located in an assembly line before or after various finishing stations.

Also, the bending tool system of the present invention allows 2D sheet material parts to be transported directly to the assembly space, and thus allows the product to be transported flat through as much of the manufacturing process as possible. Various methods can be utilized to feed the work piece to the tool base including, but not limited to, overhead vacuum delivery devices that can be used to place the work piece onto the tool base.

The single-stage configuration of the actuators is advantageous in that it induces compound bending, that is, induces bending along two bend lines during a single operational stage. As such, the configuration of the actuators reduces part count of the tools system thereby simplifying the design and reducing the manufacturing cost thereof.

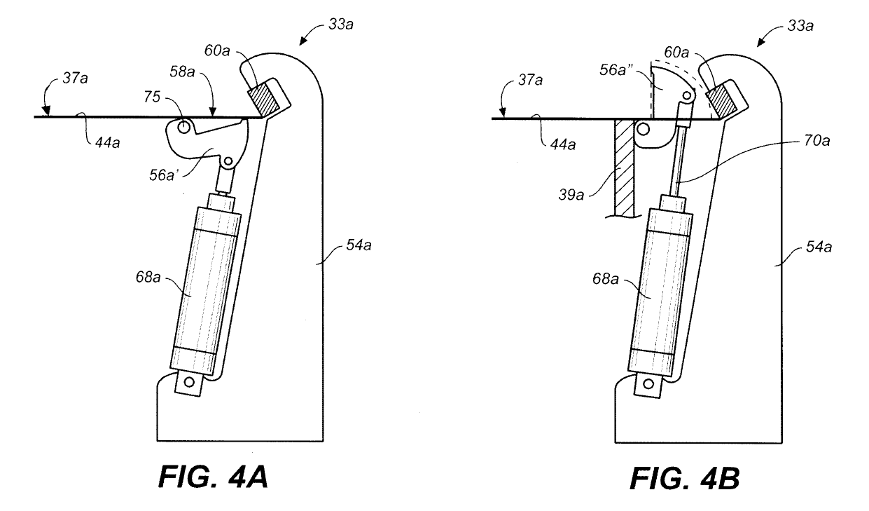

In another embodiment of the present invention shown in FIG. 4A and FIG. 4B, bend actuator 33a is similar to bend actuator 33 described above but is configured to act upwardly instead of downwardly. Like reference numerals have been used to describe like components of bend actuator 33 and bend actuator 33a. In this embodiment, application member 56a is pivotally mounted for pivotal motion with respect to the tool base. For example, the application member may be pivotally mounted to support wall 39a for pivotal motion about pivot axis 75. In operation and use, bend actuator 33a is used in substantially the same manner as bend actuator 33 discussed above.

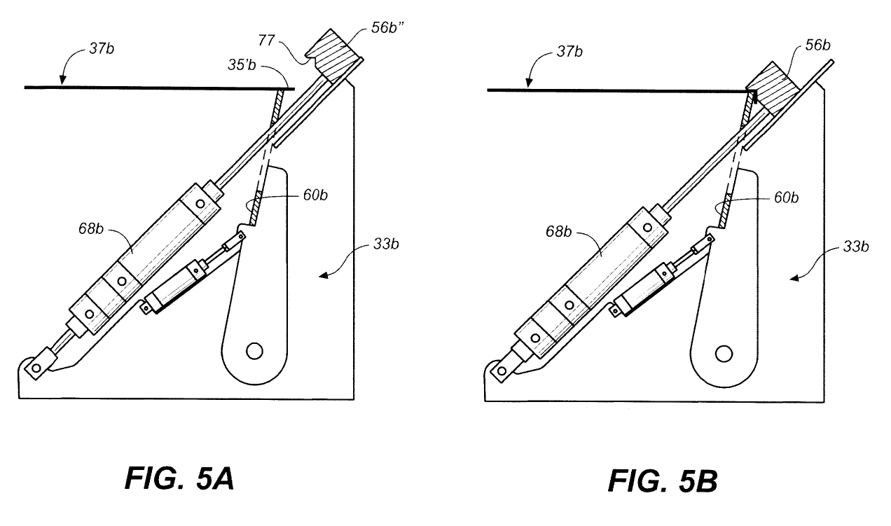

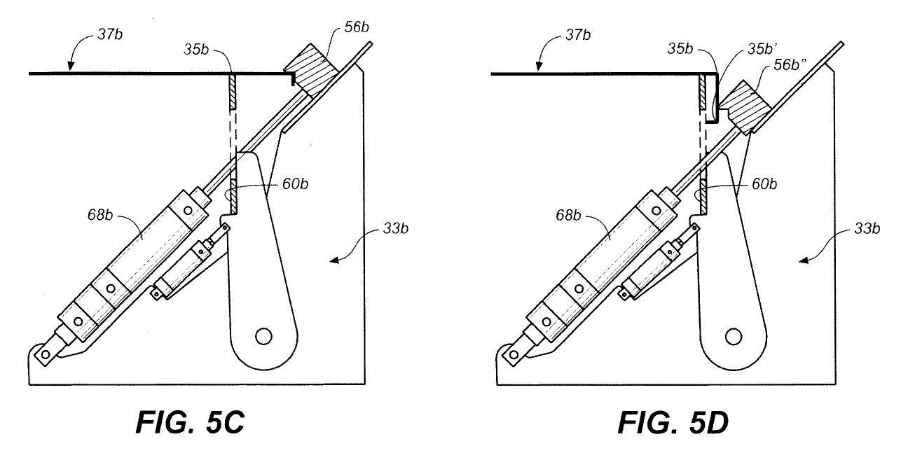

In another embodiment of the present invention shown in FIG. 5A through FIG. 5D, bend actuator 33b is similar to the bend actuators described above but includes a moveable contact member 60b. Like reference numerals have been used to describe like components of bend actuator 33b and bend actuators 33 and 33a. In this embodiment, application member 56b includes a flange notch 77. Cylinder 68b is configured to move the application member downward such that the flange notch contacts work piece 37b and bends the work piece about outer fold line 35b′ thereby forming flange 47b. A supplemental cylinder 79 than translates contact member 60b inwardly beyond inner fold line 35b as shown in FIG. 5C. Continued downward motion of application member 56b effects folding about the inner fold line, as illustrated in FIG. 5D. In operation and use, bend actuator 33b is used in substantially the same manner as bend actuators 33 and 33a discussed above.

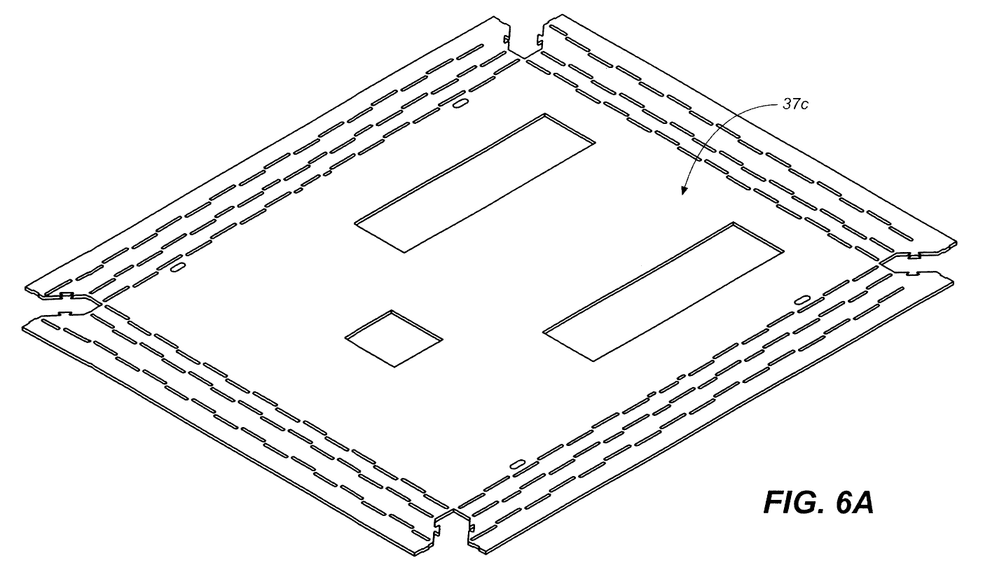

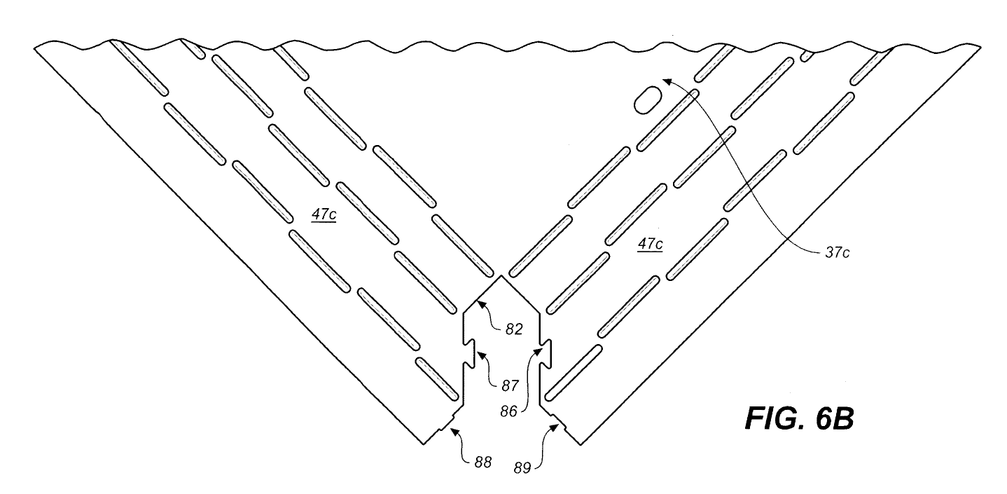

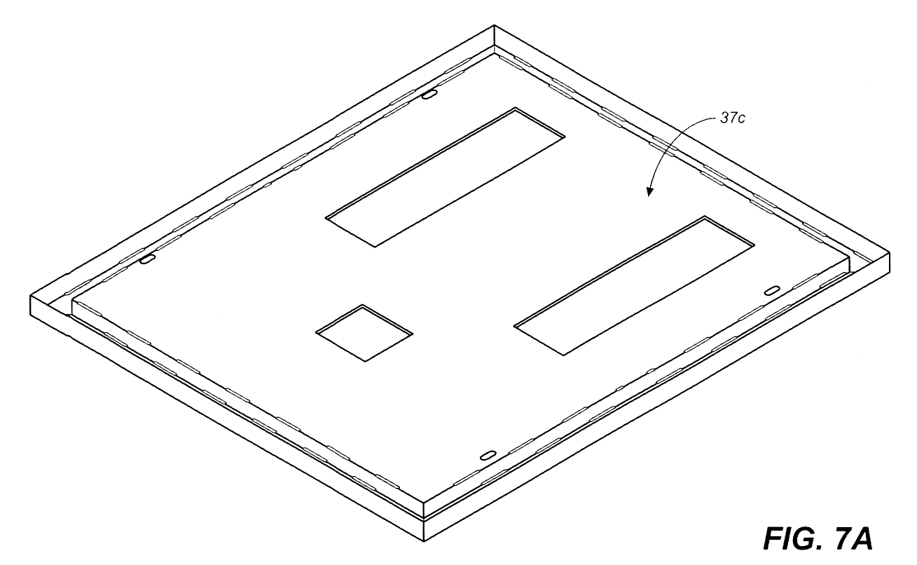

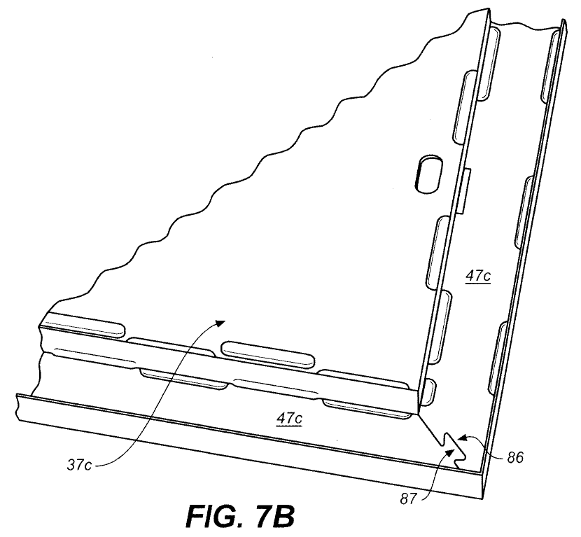

Turning now to FIG. 6A and FIG. 6B, a sheet material work piece 37c is illustrated which is configured for folding into a utility box having an integral frame structure 81, as shown in FIG. 7A and FIG. 7B. The work piece includes inner and outer fold lines 35c and 35c′ in a manner similar to the work pieces described above, but also includes a further fold line 35c″, as most clearly seen in FIG. 6B. In this embodiment, the work piece has a corner notch 82 that if dimensioned and configured to form a self-locking corner. One flange 47c is provided with a key 84, while and adjacent flange 47c′ is provided with a keyway 86. One will appreciate that the bend actuators may be configured such that key 84 is automatically inserted into keyway 86 during the folding process. For example, the sequence may be ordered such that the key is folded into the keyway during the bending process, resulting in the secured finished corner shown in FIG. 7B.

The work piece further includes a locking tab 88 and a locking recess 89 which are dimensioned and configured to affix Z-axis motion between key 84 and keyway 86 once the work piece has been assembled, that is, folded along fold lines 35c, 35c′ and 35c″, as shown in FIG. 7B.

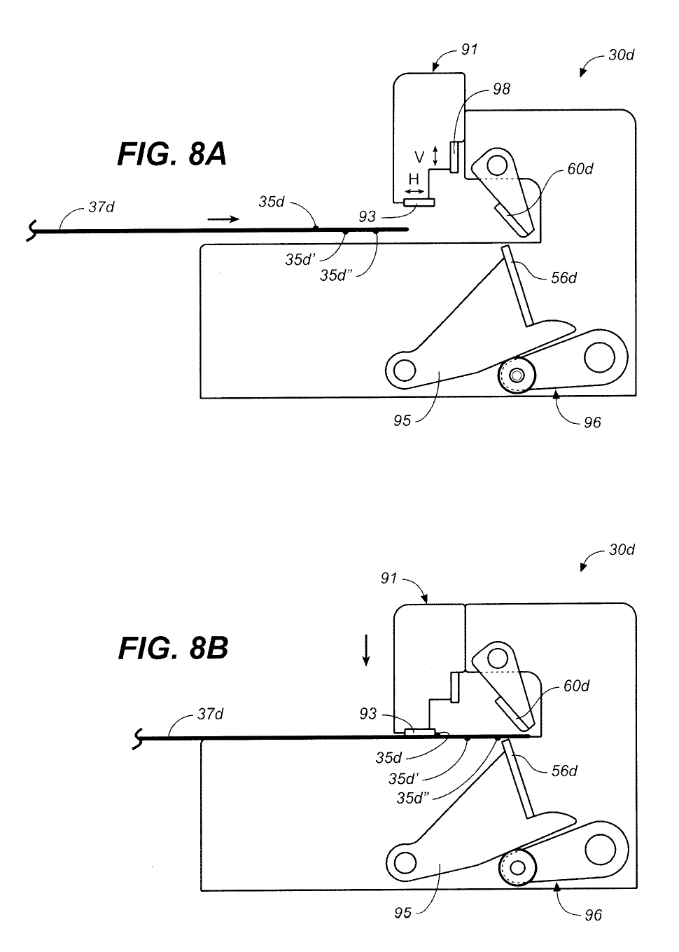

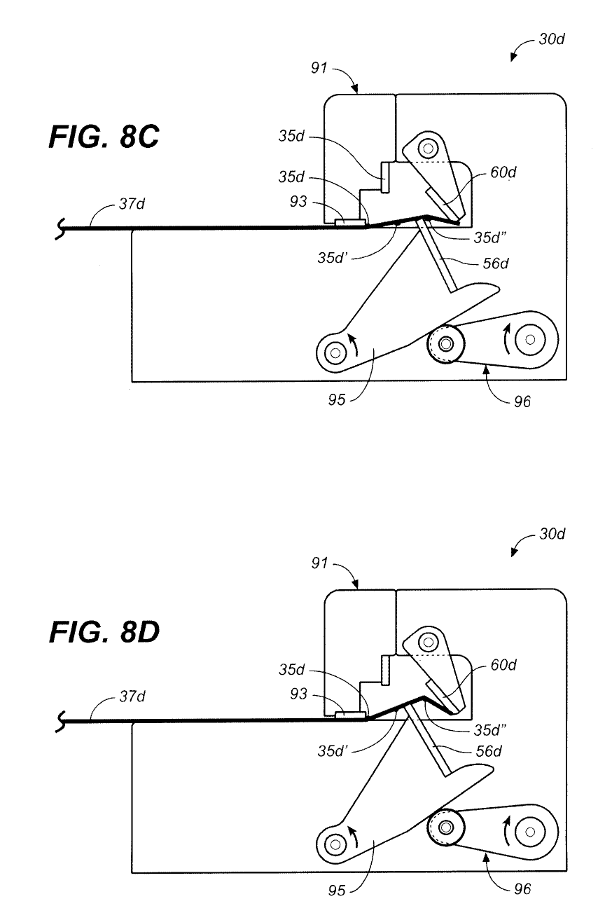

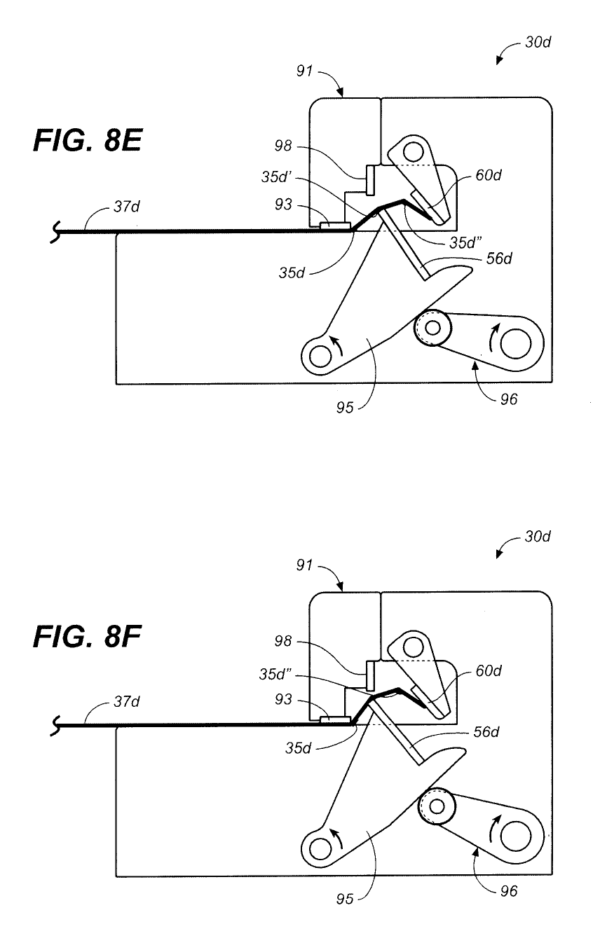

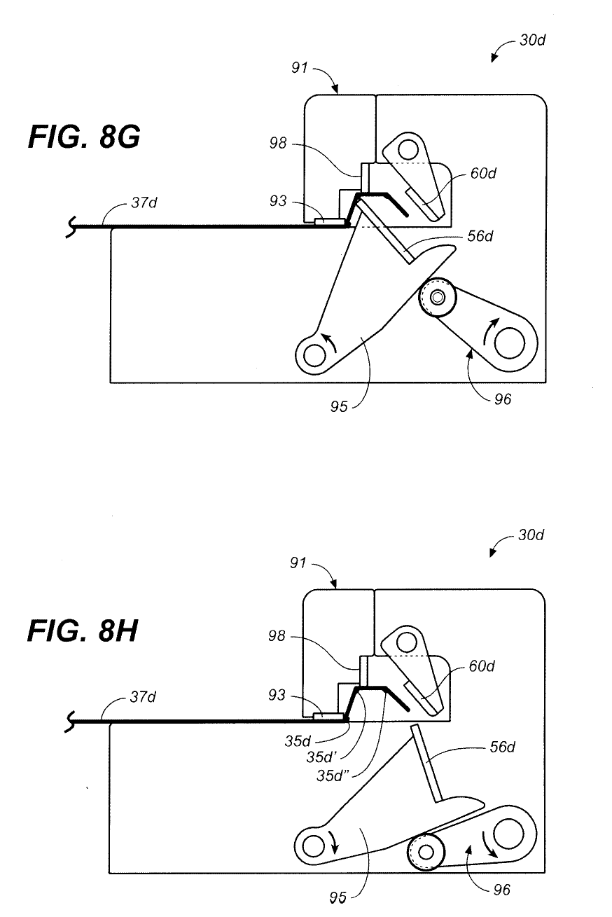

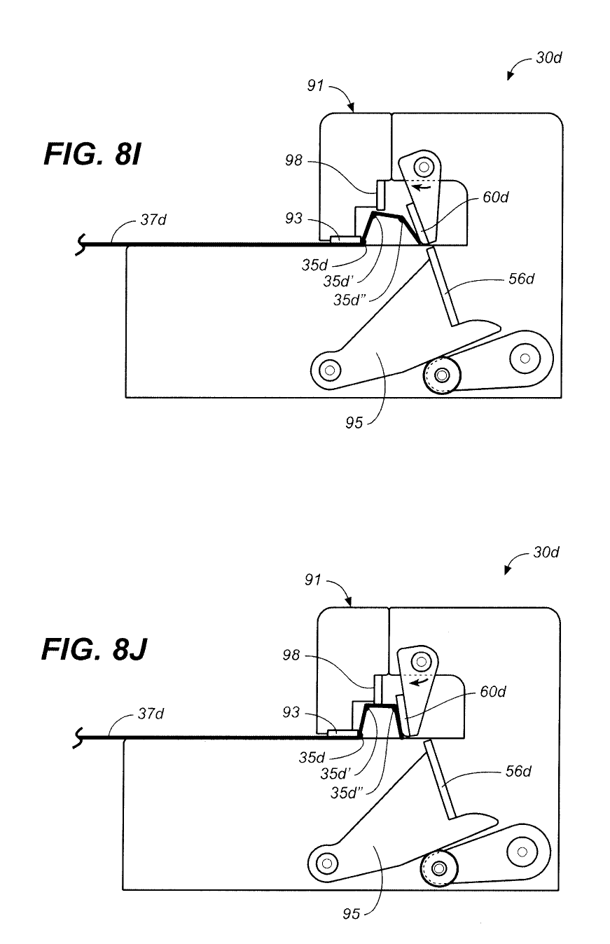

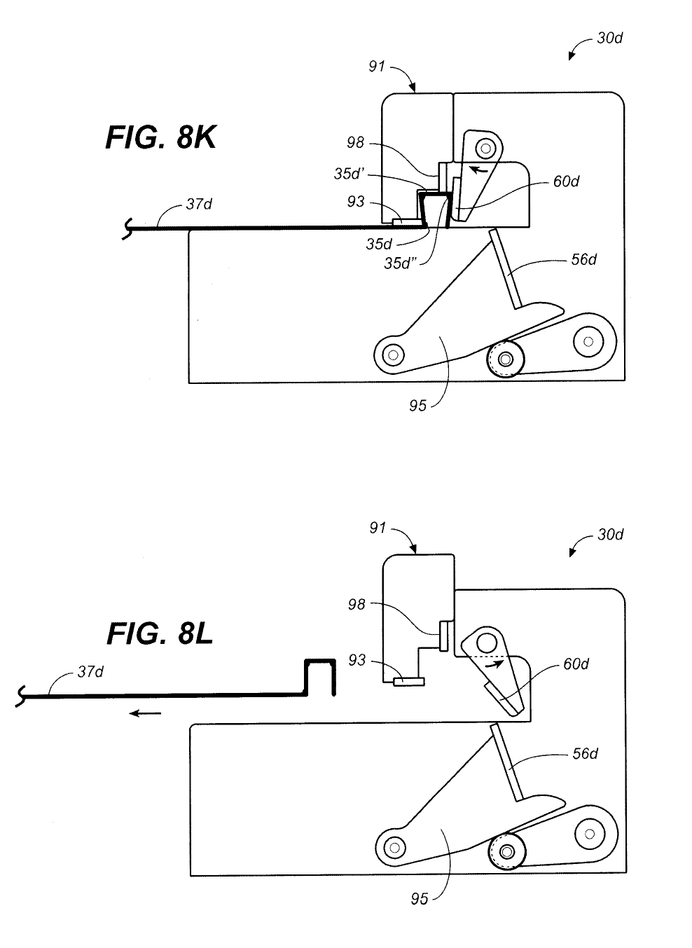

In another embodiment of the present invention shown in FIG. 8A through FIG. 8L, bend actuator 33d is similar to the bend actuators described above but includes two moveable restraints in the form of contact member 60d and a clamp member 91. Like reference numerals have been used to describe like components of bend actuator 33d and the above bend actuators.

In this embodiment, work piece 37d is placed upon the tool system (FIG. 8A) such that fold line 35d is located immediately adjacent static restraint member 93 as clamp member 91 is lowed and secures the work piece relative to the tool system (FIG. 8B). Application member 56d is mounted on a cam body 95 that is driven by a drive assembly 96 such that the application member contacts the work piece between adjacent fold line 35d′, and preferably between fold lines 35d′ and 35d″ (FIG. 8C). In the illustrated embodiment, the drive assembly is a cam roller/lever assembly, however, one will appreciate that other suitable means may be used to move the application member.

As the application member pushes the work piece upward, the work piece begins to fold about fold line 35d by virtue of the static restraint of the work piece by static restraint member 93, and as the work piece continues upward, the work piece begins to fold about fold line 35d″ by virtue of the dynamic restraint of the work piece by contact member 60d. In particular, the contact member dynamically restrains the outermost portion of the work piece, that is, the portion outside of fold line 35d″, by restraining movement of the outer or peripheral edge of the work piece as it abuts against contact member 60d (FIG. 8C) and, as bending continues about fold line 35d″, by restraining movement of the peripheral edge as it slides along contact member 60d (FIG. 8D).

As bending further continues, application member 56d further pushes work piece 37d upward. The upper edge of the application slides along the work piece toward fold line 35d (FIG. 8E and FIG. 8F) such that the uppermost edge of application member 56d is between static restraint member 93 and an upper restraint member 98 (FIG. 8G) and preliminarily forms a folded corner along fold line 35d. Deformation of the work piece along the fold line will hold the preliminary folded corner as application member 56d retreats (FIG. 8H).

Once application member 56d retreats or at least clears contact member 60d, the contact member advances and pushes against the outermost portion of work piece 37d such that further folding occurs about fold lines 35d, 35d′, 35d″ (FIG. 8J and FIG. 8J). Preferably, contact member 60d pushes the outermost portion of the work piece a sufficient amount to bend the work piece about each of the bend lines slightly beyond 90° (FIG. 8K) in order to accommodate for “spring back” of the work piece and provide the work piece with an ultimate shape in which each corner is approximately 90° (FIG. 8L). Once contact member 60d retreats and clamp member 91 is released, folded work piece 37d may be removed from the tool system (FIG. 8L).

Preferably, the positions of static restrain member 93 and upper restraint member 98 are adjustable (see arrows H and V in FIG. 8) to as to “tune” the amount of bending along the fold lines and thus ensure that the ultimate shape of the work piece has 90° corners (or other desired angle(s)) along the fold lines. Also, the rotational limits of application member 56d and the contact member 60d are similarly adjustable. While preferred, one will appreciate that such adjustments are not essential.

For convenience in explanation and accurate definition in the appended claims, the terms “upward”, “downward”, “inner”, “outer” and other relational terms are used to describe features of the present invention with reference to the positions of such features as displayed in the figures.

In many respects the modifications of the various figures resemble those of preceding modifications and the same reference numerals followed by subscripts a “b”, “c”, and “d” designate corresponding parts.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A bending tool system for forming a three-dimensional structure from a two-dimensional sheet material which includes first and second predetermined fold lines, the system comprising:
a tool base for receiving and supporting the sheet material;
a locator for positioning the sheet material relative to the work base;
a bend actuator mounted on the tool base, the bend actuator including
an actuator member movable between an initial retracted position and a deployed extended position for applying a force against an unsecured portion of sheet material to effect bending of the sheet material about the first fold line as the actuator member moves from the initial retracted position and contacts the unsecured portion; and
a contact member positioned to abut against an outer portion of the unsecured portion as the actuator member continues to bend the sheet material about the first fold line, wherein the contact member effects bending of the sheet material along the second fold lines as the actuator member continues moving toward the deployed extended position.

2. A system according to claim 1, wherein the tool base includes clamping means for securing the sheet material to the tool base.

3. A system according to claim 1, the bend actuator further comprising a driver operably connected to the application member, wherein actuation of the driver moves the application member between the initial retracted position and the deployed extended position.

4. A system according to claim 3, wherein the driver is a pneumatic cylinder having a cylinder stroke, wherein a first portion of the cylinder stroke effects movement of the actuator member to contact the unsecured portion and effect bending about the first fold line, and a second portion of the cylinder stroke effects movement of the actuator member effect bending along the second fold line.

5. A system according to claim 4, wherein the second portion of the cylinder stroke also continues to effect bending about the first fold line.

6. A system according to claim 1, wherein the sheet material has a plurality of sets of predetermined fold lines, the system comprising a plurality of bend actuators, each bend actuator positioned to effect bending along a respective set of fold lines.

7. A system according to claim 1, further comprising a mounting bracket connecting the bend actuator to the tool base.

8. A system according to claim 7, wherein the mounting bracket adjustably secures the bend actuator to the tool base.

9. A system according to claim 7, further comprising a contact member bracket adjustably mounting the contact member on the mounting bracket.

10. A system according to claim 9, further comprising a height adjuster for adjusting the height of the contact member with respect to the mounting bracket and the tool base.

11. A system according to claim 9, further comprising a angle adjuster for adjusting the angle of the contact member with respect to the mounting bracket and the tool base.

12. A system according to claim 1, wherein the actuator member is pivotally mounted a pivot axis, wherein the pivot axis is fixed with respect to the tool base.

13. A system according to claim 1, the bend actuator further comprising a supplemental cylinder to pivot the contact member from an outer position adjacent the second fold line to an inner position adjacent the first fold line.

14. A method for forming a three-dimensional structure from a two-dimensional sheet material which includes first and second predetermined fold lines, the method comprising the steps:
positioning a sheet material on a tool base for receiving and supporting the sheet material in a work plane;
initially moving an actuator member from an initial retracted position and applying a force against an unsecured portion of sheet material to effect bending of the sheet material about the first fold line as the actuator member contacts the unsecured portion and continues to move to an intermediate position at which the unsecured portion contacts a contact member; and
continually moving the actuator member from the first intermediate portion and beyond the intermediate position to continue bending the sheet material about the first fold line such that the unsecured member slides along the contact member to effect bending of the sheet material along the second fold lines as the actuator member continues moving toward the deployed extended position.

15. A method according to claim 14, further comprising the step of clamping the sheet material to the tool base.

16. A method according to claim 14, wherein the initially moving and the continually moving steps are effectuated by pneumatically moving the application member.

17. A method according to claim 14, further comprising the step of adjustably securing the bend actuator to the tool base.

18. A method according to claim 14, further comprising the step of adjustably mounting the contact member with respect to the tool base.
